(19) United States
(12) Patent Application Publication
(10) Pub. No.: US 2025/0264203 A1
(43) Pub. Date: Aug. 21, 2025

(54) LAMP SYSTEM FOR MOVING OBJECTS AND ITS CONTROL METHOD

(71) Applicant: HYUNDAI MOBIS CO., LTD., Seoul (KR)

(72) Inventors: Yun Ji HEO, Seoul (KR); Dong Hwa KANG, Suwon-si (KR)

(73) Assignee: HYUNDAI MOBIS CO., LTD., Seoul (KR)

(21) Appl. No.: 18/909,080

(22) Filed: Oct. 8, 2024

(30) Foreign Application Priority Data
Feb. 15, 2024 (KR) 10-2024-0021505

(51) Int. Cl. F21S 41/65; F21W 102/13; F21W 102/20; G01S 13/08; G06T 7/70

(52) U.S. Cl. CPC F21S 41/65; G01S 13/08; G06T 7/70; F21W 2102/13; F21W 2102/20; G06T 2207/30252

(57) ABSTRACT

Provided are a lamp system for moving objects and its control method, and more particularly, the system including: a light source unit including a plurality of light sources, and generating a beam of a predetermined shape and outputting the generated beam to outside a vehicle; a sensor unit including at least one of a camera sensor and a radar sensor, and providing sensing data of a preceding vehicle; and a control unit controlling the output of the light source unit based on the sensing data received from the sensor unit, wherein the control unit calculates a separation distance of the vehicle from the preceding vehicle based on the sensing data received from the sensor unit, and controls the output of the light source unit based on the calculated separation distance.

### CROSS-REFERENCE TO RELATED APPLICATIONS

This application claims priority under 35 U.S.C. § 119 to Korean Patent Application No. 10-2024-0021505, filed on Feb. 15, 2024, in the Korean Intellectual Property Office, the disclosure of which is incorporated herein by reference in its entirety.

### TECHNICAL FIELD

The following disclosure relates to a lamp system for moving objects and its control method, and more particularly, to a lamp system for moving objects that controls an amount of light from a lamp for moving objects based on a distance from a preceding vehicle, and its control method.

### BACKGROUND

Traffic accident fatalities are higher at night than during the day because driver visibility at night is significantly narrower than driver visibility during the day. In general, headlamps of a vehicle may include a high beam and a low beam. Among the headlamps, the low beam is designed to direct light below the horizon, thus limiting the visibility to only a short distance of the road. The driver may thus have difficulty in securing sufficient long-distance visibility when driving at night. On the other hand, the high beam assists the driver to secure the visibility enabling the driver to see an object far away. However, the high beam may cause glare to a driver riding in another vehicle in front of the driver, and thus have a limitation in its use.

An adaptive driving beam (ADB) system is a system to solve these problems, and may be a system that combines advantages of the low beam causing no glare and the high beam securing the driver visibility. In detail, the ADB system uses technology that maintains the high beam during night driving and prevents the glare to another driver when a vehicle appears in front of the vehicle or in the opposite lane. To describe in more detail, the ADB system may use a principle of identifying a vehicle through a camera sensor, selectively dimming only a part that causes the glare to another driver, and then turning the corresponding part back on when the vehicle passes by. Through this operation, the ADB system may allow the driver to secure the sufficient night visibility without causing the glare to another driver.

However, there may be an area where the visibility is unnecessarily secured among the visibility provided by an existing ADB system. That is, in a situation where the visibility is unnecessary, the existing ADB system may allow the lamp to emit the same amount of light, which may result in excessive waste of power consumption. As sustainability and related energy consumption trends are continuously increasing, such power waste has become a more important issue, thus also making efficient power consumption important.

### SUMMARY

An embodiment of the present disclosure is directed to providing a lamp system for moving objects that may reduce power consumption by changing the brightness of a lamp based on its distance from a preceding vehicle, and its control method.

In one general aspect, provided is a lamp system for moving objects, the lamp system including a light source unit including a plurality of light sources, the light source unit generating a beam having a predetermined shape and configured to output the generated beam to an outside of a vehicle; a sensor unit including at least one of a camera sensor and a radar sensor, and configured to provide sensing data corresponding to a preceding vehicle; and a control unit controlling the output of the light source unit based on the sensing data received from the sensor unit, wherein the control unit is configured to calculate a separation distance from the vehicle to the preceding vehicle based on the sensing data received from the sensor unit, and is configured to control the output of the light source unit based on the calculated separation distance.

The control unit may be configured to set a first masking area based on lanes on two sides of the vehicle, control the output of the light source unit based on the separation distance and the first masking area, and control a light quantity of the first masking area such that the light quantity is less than or equal to a predetermined reference.

The control unit may be configured to set a second masking area based on the calculated separation distance, control the output of the light source unit based on the second masking area, reduce the second masking area in response to an increase in the separation distance, and control a light quantity of the second masking area such that the light quantity of the second masking area is less than or equal to a predetermined reference.

The control unit may be configured to, for each light source in the plurality of light sources, controls output of the light sources based on the calculated separation distance and a beam emission range corresponding to a pre-stored vertical angle of the light source unit, and at least one light source may have an output that is different from at least one other light source that is vertically adjacent thereto.

The control unit may be configured to receive reference inter-vehicle distance information based on a vehicle speed, and control the output of the light source unit based on the received reference inter-vehicle distance information and the separation distance.

The control unit may be configured to control the output of the light source unit based on the calculated separation distance, and turn on the light source in response to an error that occurs in the plurality of light sources during the output of the light source unit.

In another general aspect, provided is a control method of a lamp system for moving objects, which includes a light source unit that generates a beam of a predetermined shape and outputs the generated beam to an outside of a vehicle and a sensor unit, the method including: (a) receiving, by a control unit, sensing data from the sensor unit; (b) calculating, by the control unit, a separation distance from the vehicle to the preceding vehicle based on the sending data received from the sensor unit and (c) controlling, by the control unit, the output of the light source unit based on the calculated separation distance.

In some embodiments, the method further includes, by the control unit, setting a first masking area based on lanes on two sides of the vehicle, and, controlling the output of the light source unit based on the separation distance and the first masking area such that a light quantity of the first masking area is lowered to a predetermined reference or less.

In some embodiments, the method further includes, by the control unit, setting a second masking area based on the calculated separation distance, controlling the output of the light source unit based on the second masking area, in response to an increase in the separation distance, reducing the the second masking area, and controlling a light quantity of the second masking area such that it is lowered to a predetermined reference or less.

In some embodiments the method further includes, by the control unit, for each light source in the plurality of light sources, controlling the output of the light source based on the calculated separation distance and a beam emission range corresponding to a pre-stored vertical angle of the light source unit, and at least one light source has an output that is different from at least one other light source that is vertically adjacent thereto.

In some embodiments, the method further includes, by the control unit, receiving reference inter-vehicle distance information based on a vehicle speed from the outside, and controlling the output of the light source unit based on the received reference inter-vehicle distance information and the separation distance.

In some embodiments, the method further includes, by the control unit, controlling the output of the light source unit based on the calculated separation distance, and turning on a light source in response to t an error occuring among the plurality of light sources during the output of the light source unit.

Other features and aspects will be apparent from the following detailed description, the drawings, and the claims.

### BRIEF DESCRIPTION OF THE DRAWINGS

FIG. 1 is a schematic diagram of a lamp system for moving objects according to an embodiment of the present disclosure.

FIG. 2 is a diagram showing a ground-level light distribution pattern according to an embodiment of the present disclosure.

FIG. 3 is a diagram showing a ground-level light distribution pattern according to an embodiment of the present disclosure.

FIG. 4 is a diagram showing a ground-level light distribution pattern according to an embodiment of the present disclosure.

FIG. 5 is a diagram showing a low-beam cutoff pixel according to an embodiment of the present disclosure.

FIG. 6 is a diagram showing a low-beam cutoff pixel according to another embodiment of the present disclosure.

FIG. 7 is a diagram showing a low-beam cutoff pixel according to another embodiment of the present disclosure.

FIG. 8 is a diagram showing pixels that complement each other in a non-compliance (NG) area according to another embodiment of the present disclosure.

FIG. 9 is a flowchart showing a control method of a lamp system for moving objects according to another embodiment of the present disclosure.

### DETAILED DESCRIPTION OF EMBODIMENTS

In order to describe the present disclosure, operational advantages of the present disclosure, and objects accomplished by embodiments of the present disclosure, the embodiments of the present disclosure are hereinafter exemplified and described with reference to the accompanying drawings.

First, terms used in this application are used only to describe specific embodiments rather than limiting the present disclosure, and a term of a singular number may include its plural number unless explicitly indicated otherwise in the context. In addition, it is to be understood that terms “include,” “have”, and the like used in this application specify the existence of features, numerals, steps, operations, components, parts, or combinations thereof, which are mentioned in the specification, and do not preclude the existence or addition of one or more other features, numerals, steps, operations, components, parts, or combinations thereof.

Omitted is a description of a case where it is decided that the detailed description of the known configuration or function related to the present disclosure may obscure the gist of the present disclosure.

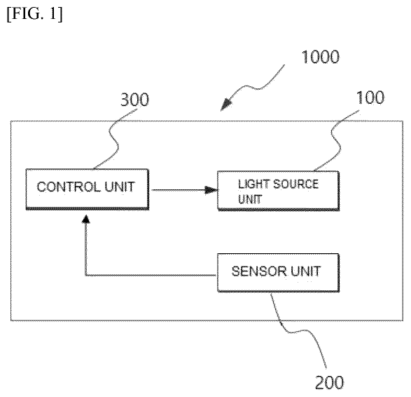

FIG. 1 is a schematic diagram of a lamp system for moving objects according to an embodiment of the present disclosure.

As shown in FIG. 1, a lamp system 1000 for moving objects according to the present disclosure may include a light source unit 100, a sensor unit 200, and a control unit 300.

The light source unit 100 may include a plurality of light sources, and the plurality of light sources may generate a beam of a predetermined shape and output the generated beam outside a vehicle. In detail, the beam of a predetermined shape may be a low beam.

The sensor unit 200 may include at least one type of sensor and may detect a preceding vehicle and provide sensing data of the preceding vehicle. In detail, the sensor unit 200 may include at least one of a camera sensor or a radar sensor.

The control unit 300 may receive the sensing data from the sensor unit 200, and control the output of the light source unit 100 based on the received sensing data.

In detail, the control unit 300 may calculate a separation distance of the vehicle from the preceding vehicle based on the received sensing data. The control unit 300 may then control the output of the light source unit 100 based on the calculated separation distance.

### First Embodiment

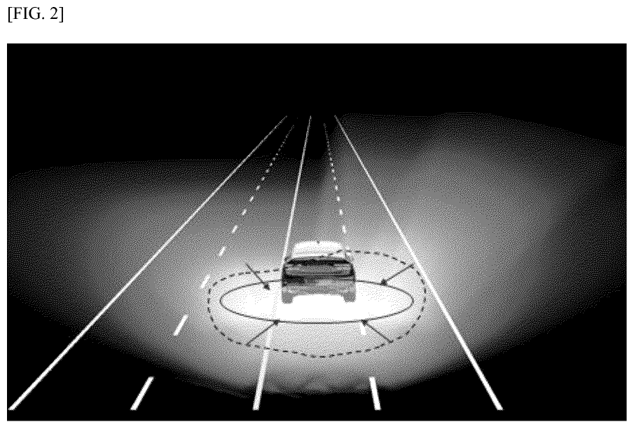

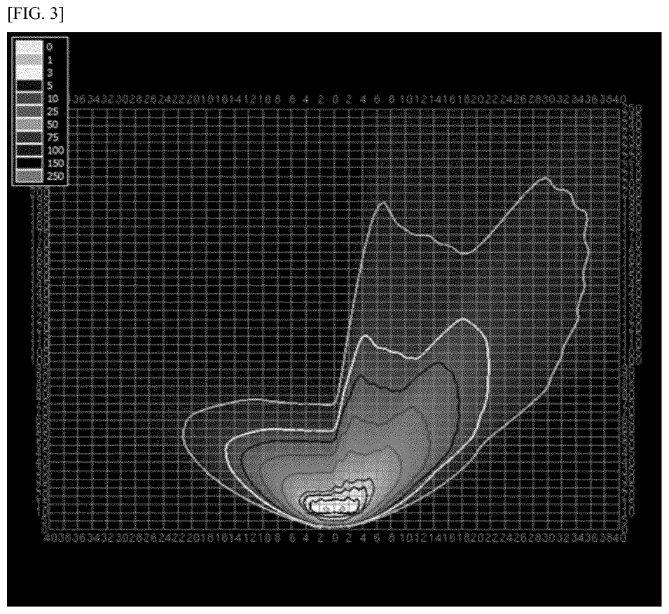

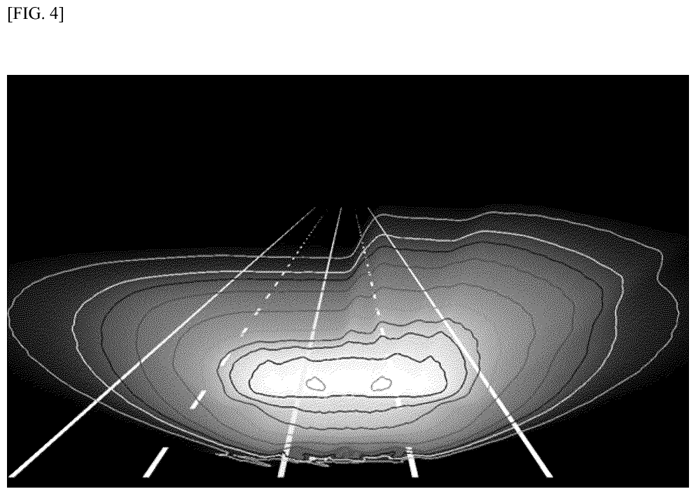

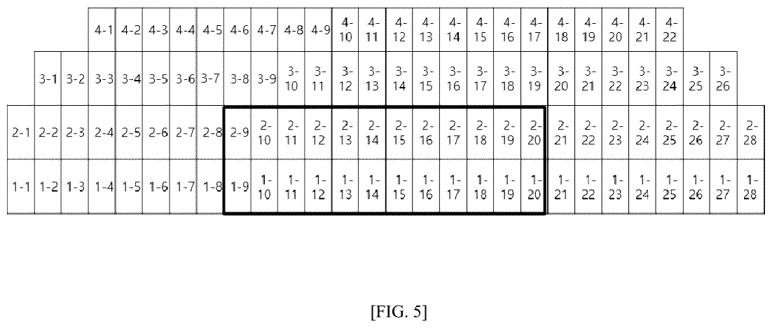

FIGS. 2 to 4 are diagrams each showing a ground-level light distribution pattern according to an embodiment of the present disclosure; and FIG. 5 is a diagram showing a low-beam cutoff pixel according to an embodiment of the present disclosure. Specifically, 1-1 to 4-22 shown in FIG. 5 all refer to individual light sources.

As shown in FIGS. 2 to 5, in the lamp system 1000 for moving objects according to the present disclosure, the control unit 300 may control the output of the light source unit 100 based on a position of the vehicle's own lane.

In detail, the control unit 300 may set a first masking area based on lanes on two sides of the vehicle. The control unit 300 may then control the output of the light source unit 100 based on the separation distance from the preceding vehicle and the first masking area.

Here, the control unit 300 may control light quantity of the first masking area to be lowered to a predetermined reference or less.

In this way, the control unit 300 may lower the light quantity of the first masking area corresponding to the vehicle's own lane while maintaining light quantity of the light source disposed at each of two ends of an outer lane of the preceding vehicle at its existing level. Accordingly, the control unit 300 may prevent unnecessary power consumption while improving driver visibility by allowing no dark area to occur on the outer lane of the preceding vehicle when the preceding vehicle exists in front.

In addition, the vehicle may have light quantity of the low beam that is changed based on its separation distance from the preceding vehicle.

### Second Embodiment

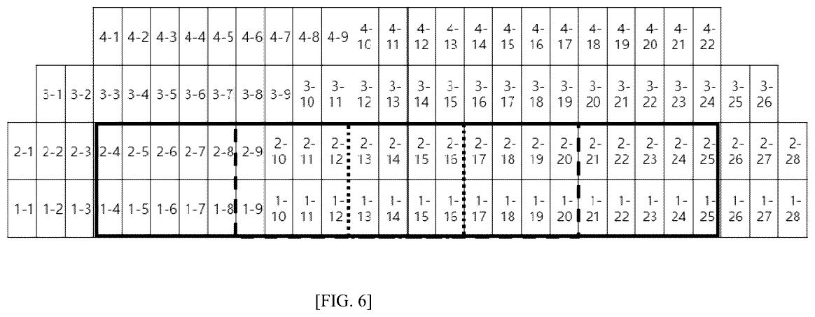

FIG. 6 is a diagram showing a low-beam cutoff pixel according to another embodiment of the present disclosure.

In the lamp system 1000 for moving objects according to the present disclosure, the control unit 300 may control the output of the light source unit 100 based on the separation distance.

In detail, as shown in FIG. 6, the control unit 300 may calculate the separation distance of the vehicle from the preceding vehicle based on the sensing data, and set a second masking area based on the calculated separation distance. The control unit 300 may then control the output of the light source unit 100 based on the second masking area.

Here, the control unit 300 may control the second masking area to be reduced as the separation distance from the preceding vehicle is increased, and similarly control light quantity of the second masking area here to be lowered to a predetermined reference or less.

In this way, the control unit 300 may use the fact that a visibility angle is changed based on the separation distance from the preceding vehicle, that is, the visibility angle is increased as an object in front gets closer and decreased as the object gets farther away. Therefore, the control unit 300 may change the second masking area based on the separation distance, and reduce the light quantity in the corresponding area, thereby securing the visibility and maximizing efficient power consumption.

### Third Embodiment

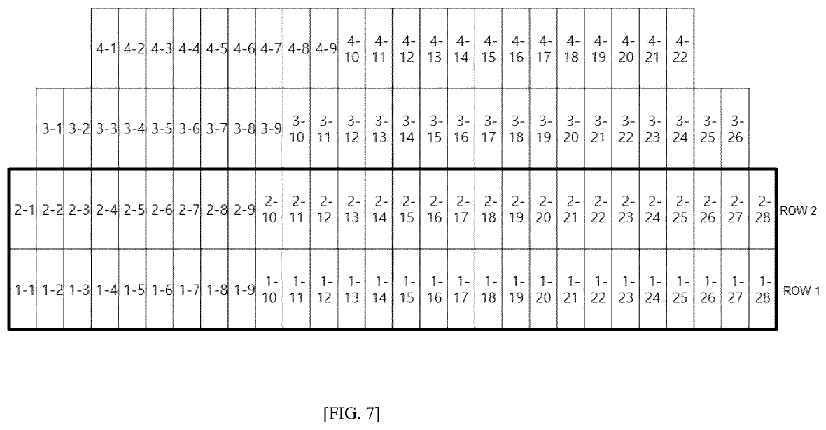

FIG. 7 is a diagram showing a low-beam cutoff pixel according to another embodiment of the present disclosure.

In the lamp system 1000 for moving objects according to the present disclosure, the control unit 300 may control the output of the light source unit 100 based on vehicle angle information.

In detail, as shown in FIG. 7, the control unit 300 may control the output of the light source unit 100 based on the separation distance from the preceding vehicle and a low-beam emission range corresponding to a pre-stored vertical angle of the light source unit 100.

In more detail, the control unit 300 may control a position of a pattern receiving light emission differently based on a vertical angle of the low beam. The control unit 300 may control the output of the plurality of light sources, which are included in the light source unit 100 and vertical to each other, differently based on the low-beam emission range corresponding to the vertical angle.

For example, when a vertical angle V of the low beam is −4.79≤V≤−0.4°, the low beam may be emitted to a location of approximately 10 m to 25 m.

In addition, when the vertical angle of the low beam is −2.77≤V≤1.19°, the low beam may be emitted to a location of approximately 25 m or more.

Based on this method, the control unit 300 may reduce the power consumption by controlling the minimum light quantity for securing the visibility of the preceding vehicle and an obstacle as shown in the following examples, and perform more delicate control as its resolution is increased.
1. Vehicle 10 m ahead: Wide beam dimmed to 50%, and Matrix rows 1 and 2 off;
2. Vehicle 20 m ahead: Wide beam dimmed to 50%, Matrix row 1 dimmed to 50%, and Matrix row 2 off;
3. Vehicle 30 m ahead: Wide beam on, Matrix row 1 on, and Matrix row 2 dimmed to 50%; and
4. Vehicle 40 m or more ahead: Wide beam on, and Matrix rows 1 and 2 on.

Examples 1 to 4 described above are only embodiments, and the present disclosure is not limited thereto.

### Fourth Embodiment

In the lamp system 1000 for moving objects according to the present disclosure, the control unit 300 may control the output of the light source unit 100 based on reference inter-vehicle distance information and the separation distance.

In detail, the control unit 300 may receive the reference inter-vehicle distance information based on a vehicle speed from the outside, and control the output of the light source unit 100 based on the received reference inter-vehicle distance information and the separation distance.

In more detail, the lamp system 1000 for moving objects may be linked to a smart cruise control (SCC) to emit the optimal beam pattern for each inter-vehicle distance stage.

Here, the smart cruise control (SCC) refers to a mode for automatically controlling the speed by adjusting the distance of the vehicle from the preceding vehicle.

For example, the reference inter-vehicle distance information for each inter-vehicle distance setting speed may be 10 m, where the preceding vehicle is stopped and a stop-and-go function is thus activated, when the speed is less than 30 km/h, or may be 25 m (stage 1), 32.5 m (stage 2), 40 m (stage 3), or 52.5 m (stage 4) based on the inter-vehicle distance setting speed of the SCC when the speed is 30 km/h or more. Here, the control unit 300 may control the light source unit 100 to emit the optimal pattern for low power consumption.

### Fifth Embodiment

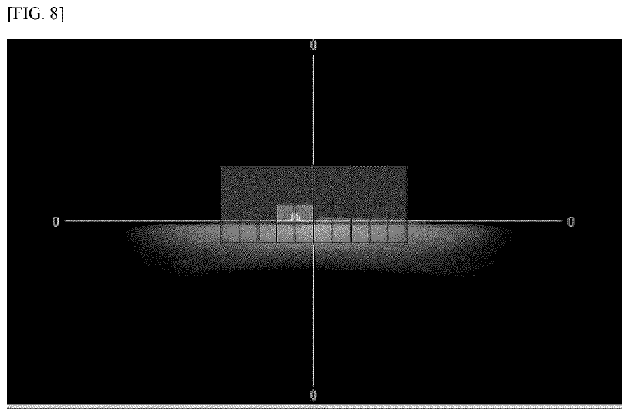

FIG. 8 is a diagram showing pixels that complement each other in a non-compliance (NG) area according to another embodiment of the present disclosure.

Meanwhile, as shown in FIG. 8, in controlling the output of the light source unit 100 based on the separation distance, the control unit 300 in the lamp system 1000 for moving objects according to the present disclosure may turn on the light source where the error occurs among the plurality of light sources of the light source unit 100 if an error occurs during the output of the light source unit 100.

In detail, the light quantity may be unable to be lower because non-compliance (NG) may occur with signal regulation even if the light quantity is slightly reduced based an existing wide beam design. Here, when the light source of a corresponding part is turned on, the light quantity may be sufficiently lower without a separate optical system design, and generate a beam pattern that satisfies the regulation.

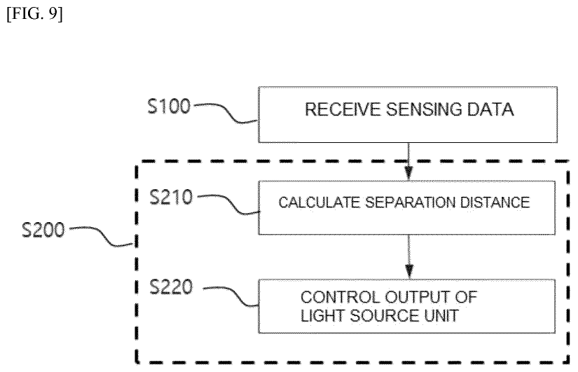

FIG. 9 is a flowchart showing a control method of a lamp system for moving objects according to another embodiment of the present disclosure.

As shown in FIG. 9, the control method of a lamp system 1000 for moving objects, which includes a light source unit 100 that generates a beam (low beam) of a predetermined shape and outputs the generated beam to outside a vehicle and a sensor unit 200, may include receiving, by a control unit 300, sensing data from the sensor unit 200 (S100); and controlling, by the control unit 300, the output of the light source unit 100 based on the received sensing data (S200).

In detail, in step S210, by the control unit 300, a separation distance of the vehicle from a preceding vehicle may be calculated based on the received sensing data. Next, in step S220, by the control unit 300, the output of the light source unit 100 may be controlled based on the calculated separation distance.

In more detail, in step S200, by the control unit 300, the output of the light source unit 100 may be controlled based on a position of the own lane.

In this step, by the control unit 300, a first masking area may be set based on lanes on two sides of the vehicle. Next, by the control unit 300, the output of the light source unit 100 may be controlled based on the separation distance from the preceding vehicle and the first masking area.

Here, by the control unit 300, light quantity of the first masking area may be controlled to be lowered to a predetermined reference or less.

In this way, by the control unit 300, the light quantity of the first masking area corresponding to the own lane may be lower while light quantity of a light source disposed at each of two ends of an outer lane of the preceding vehicle is maintained at its existing level. Accordingly, by the control unit 300, unnecessary power consumption may be prevented while driver visibility is improved by allowing no dark area to occur on the outer lane of the preceding vehicle when the preceding vehicle exists in front.

In addition, the vehicle may have light quantity of the low beam that is changed based on its separation distance from the preceding vehicle.

In addition, in step S200, by the control unit 300, the output of the light source unit 100 may be controlled based on the separation distance.

In this step, by the control unit 300, the separation distance of the vehicle from the preceding vehicle may be calculated based on the sensing data, and a second masking area may be set based on the calculated separation distance. Next, by the control unit 300, the output of the light source unit 100 may be controlled based on the second masking area.

Here, by the control unit 300, the second masking area may be controlled to be reduced as the separation distance from the preceding vehicle is increased, and similarly, light quantity of the second masking area may be controlled here to be lowered to a predetermined reference or less.

In this way, the method may use the fact that a visibility angle is changed based on the separation distance from the preceding vehicle, that is, the visibility angle is increased as an object in front gets closer and decreased as the object gets farther away. Therefore, the second masking area may be changed based on the separation distance, and the light quantity in the corresponding area may be reduced, thereby securing the visibility and maximizing efficient power consumption.

In addition, in step S200, by the control unit 300, the output of the light source unit 100 may be controlled based on vehicle angle information.

In this step, by the control unit 300, the output of the light source unit 100 may be controlled based on the separation distance from the preceding vehicle and a low-beam emission range corresponding to a pre-stored vertical angle of the light source unit 100.

In detail, by the control unit 300, a position of a pattern receiving light emission may be controlled differently based on a vertical angle of the low beam. By the control unit 300, the output of the plurality of light sources, which are included in the light source unit 100 and vertical to each other, may be controlled differently based on the low-beam emission range corresponding to the vertical angle.

For example, when a vertical angle V of the low beam is −4.79≤V≤−0.4°, the low beam may be emitted to a location of approximately 10 m to 25 m.

In addition, when the vertical angle of the low beam is −2.77≤V≤1.19°, the low beam may be emitted to a location of approximately 25 m or more.

Based on this method, by the control unit 300, power consumption may be reduced by controlling the minimum light quantity for securing the visibility of the preceding vehicle and an obstacle as shown in the following examples, and more delicate control may be performed as its resolution is increased.
1. Vehicle 10 m ahead: Wide beam dimmed to 50%, and Matrix rows 1 and 2 off;
2. Vehicle 20 m ahead: Wide beam dimmed to 50%, Matrix row 1 dimmed to 50%, and Matrix row 2 off;
3. Vehicle 30 m ahead: Wide beam on, Matrix row 1 on, and Matrix row 2 dimmed to 50%; and
4. Vehicle 40 m or more ahead: Wide beam on, and Matrix rows 1 and 2 on.

Examples 1 to 4 described above are only embodiments, and the present disclosure is not limited thereto.

In addition, in step S200, by the control unit 300, the output of the light source unit 100 may be controlled based on reference inter-vehicle distance information and separation distance.

In this step, by the control unit 300, the reference inter-vehicle distance information may be received based on a vehicle speed from the outside, and the output of the light source unit 100 may be controlled based on the received reference inter-vehicle distance information and the separation distance.

In detail, the lamp system 1000 for moving objects may be linked to a smart cruise control (SCC) to emit the optimal beam pattern for each inter-vehicle distance stage.

Here, the smart cruise control (SCC) refers to a mode for automatically controlling the speed by adjusting the distance of the vehicle from the preceding vehicle.

For example, the reference inter-vehicle distance information for each inter-vehicle distance setting speed may be 10 m, where the preceding vehicle is stopped and a stop-and-go function is thus activated, when the speed is less than 30 km/h, or may be 25 m (stage 1), 32.5 m (stage 2), 40 m (stage 3), or 52.5 m (stage 4) based on the inter-vehicle distance setting speed of the SCC when the speed is 30 km/h or more. Here, by the control unit 300, the light source unit 100 may be controlled to emit the optimal pattern for low power consumption.

In addition, in step S200, by the control unit 300, in controlling the output of the light source unit 100 based on the separation distance, the light source where an error occurs among the plurality of light sources of the light source unit 100 may be turned on if the error occurs during the output of the light source unit 100.

In this step, the light quantity may be unable to be lower because non-compliance (NG) may occur with a signal regulation even if the light quantity is slightly reduced based an existing wide beam design. Here, when the light source of a corresponding part is turned on, the light quantity may be sufficiently lower without a separate optical system design, and generate a beam pattern that satisfies the regulation.

As set forth above, the lamp system for moving objects and its control method according to the various embodiments of the present disclosure may reduce the power consumption by changing the brightness of the lamp based on its distance from the preceding vehicle.

In addition, the lamp system and its control method of the present disclosure may derive the optimal beam pattern without reducing the visibility.

In addition, the lamp system and its control method of the present disclosure may reduce the fuel consumption based on the simple control logic.

In addition, the lamp system and its control method of the present disclosure may prevent the cost increase by using the sensor mounted on the vehicle.

Although the embodiments of the present disclosure are described as above, the embodiments disclosed in the present disclosure are provided not to limit the spirit of the present disclosure but to fully describe the present disclosure. Therefore, the spirit of the present disclosure may include not only each disclosed embodiment but also a combination of the disclosed embodiments. Further, the scope of the present disclosure is not limited to these embodiments. In addition, it is apparent to those skilled in the art to which the present disclosure pertains that various variations and modifications could be made without departing from the spirit and scope of the appended claims, and all such appropriate variations and modifications should be considered as falling within the scope of the present disclosure as equivalents.

What is claimed is:

1. A lamp system for moving objects, the lamp system comprising:
a light source unit including a plurality of light sources, the light source unit generating a beam having a predetermined shape and configured to output the generated beam to an outside of a vehicle;
a sensor unit including at least one of a camera sensor and a radar sensor, and configured to provide sensing data corresponding to a preceding vehicle; and
a control unit controlling the output of the light source unit based on the sensing data received from the sensor unit,
wherein the control unit is configured to calculate a separation distance from the vehicle to the preceding vehicle based on the sensing data received from the sensor unit, and is configured to control the output of the light source unit based on the calculated separation distance.

2. The system of claim 1, wherein the control unit is configured to set a first masking area based on lanes on two sides of the vehicle, control the output of the light source unit based on the separation distance and the first masking area, and control a light quantity of the first masking area such that the light quantity is less than or equal to a predetermined reference.

3. The system of claim 1, wherein the control unit is configured to set a second masking area based on the calculated separation distance, control the output of the light source unit based on the second masking area, reduce the second masking area in response to an increase in the separation distance, and control a light quantity of the second masking area such that the light quantity of the second masking area is less than or equal to a predetermined reference.

4. The system of claim 1, wherein the control unit is configured to, for each light source in the plurality of light sources, controls output of the light sources based on the calculated separation distance and a beam emission range corresponding to a pre-stored vertical angle of the light source unit,
wherein at least one light source has an output that is different from at least one other light source that is vertically adjacent thereto.

5. The system of claim 1, wherein the control unit is configured to receive reference inter-vehicle distance information based on a vehicle speed, and control the output of the light source unit based on the received reference inter-vehicle distance information and the separation distance.

6. The system of claim 1, wherein the control unit is configured to control the output of the light source unit based on the calculated separation distance, and turns on the light source in response to an error that occurs in the plurality of light sources during the output of the light source unit.

7. A control method of a lamp system for moving objects, which includes a light source unit that generates a beam of a predetermined shape and outputs the generated beam to an outside of a vehicle and a sensor unit, the method comprising:
(a) receiving, by a control unit, sensing data from the sensor unit;
(b) calculating, by the control unit, a separation distance from the vehicle to the preceding vehicle based on the sending data received from the sensor unit; and
(c) controlling, by the control unit, the output of the light source unit based on the calculated separation distance.

8. The method of claim 7, further comprising, by the control unit:
setting a first masking area based on lanes on two sides of the vehicle; and
controlling the output of the light source unit based on the separation distance and the first masking area such that a light quantity of the first masking area is lowered to a predetermined reference or less.

9. The method of claim 7, further comprising by the control unit:
setting a second masking area based on the calculated separation distance;
controlling the output of the light source unit based on the second masking area;
in response to an increase in the separation distance, reducing the the second masking area; and
controlling a light quantity of the second masking area such that it is lowered to a predetermined reference or less.

10. The method of claim 7, further comprising, by the control unit, for each light source in the plurality of light sources:
controlling output of the light sources based on the calculated separation distance and a beam emission range corresponding to a pre-stored vertical angle of the light source unit,
wherein at least one light source has an output that is different from at least one other light source that is vertically adjacent thereto.

11. The method of claim 7, further comprising, by the control unit:
receiving reference inter-vehicle distance information based on a vehicle speed; and
controlling the output of the light source unit based on the received reference inter-vehicle distance information and the separation distance.

12. The method of claim 7, further comprising, by the control unit:
controlling the output of the light source unit based on the calculated separation distance, and
turning on a light source in response to an error occuring among the plurality of light sources during the output of the light source unit.
